(19) United States
(12) Patent Application Publication
(10) Pub. No.: US 2002/0197433 A1
(43) Pub. Date: Dec. 26, 2002

(54) Component for use in manufacture of printed circuit boards and laminates

(76) Inventor: Robert Fidrych, Palm Harbor, FL (US)

Correspondence Address: MASON & ASSOCIATES, PA, 17757 US HWY 19 N., SUITE 500, CLEARWATER, FL, 33764, US

(21) Appl. No.: 09/886,682

(22) Filed: Jun. 21, 2001

(51) Int. Cl. B32B 7/06

(52) U.S. Cl. 428/40.1; 428/194

(57) ABSTRACT

A component for use in manufacturing articles such as printed circuit boards includes a laminate of one or two sheets of copper foil and a temporary releasable laminate sheet with an adhesive applied to the interface between the temporary releasable laminate sheet and the one or two sheets of foil such that when the temporary releasable laminate sheet is separated from the foil, the surface of the sheet(s) of foil remain substantially uncontaminated.

### BACKGROUND OF THE INVENTION

1. Field of the Invention

The invention relates to printed circuit boards in general and more specifically to components employed in the manufacturing of printed circuit boards, laminates and other articles.

2. Description of Related Art

In its elementary form, a printed circuit board or laminate includes, as a component, a dielectric layer of an epoxy resin-impregnated woven glass fiber which is known as “prepreg”. On the opposite sides of the prepreg are bonded conductive foil sheets, typically copper. Subsequently the copper, through a number of photographic processes, is etched to produce conductive paths on the surface of the prepreg layer. When so assembled, the lamination is often called a core or a board. Another description of such a laminate is an assembly of foils on one or both sides with an electrically insulative dielectric in the center which can be, for example, a resin coated reinforced glass or series thereof, a continuous film, or a resin coated material.

As described in U.S. Pat. No. 5,153,050 to Johnston, in the manufacturing process, it is not uncommon to assemble a stack of such boards, either of the elementary type described above, or with compound layers. The assembly is called a press lay-up and the stack is called a book. The entire book is heated and subject to pressure. After cooling and curing, the then bonded individual boards are separated from each other and subjected to further processing. This general technique is further described in U.S. Pat. No. 4,875,283 to Johnston.

Of tantamount importance in the manufacturing procedure is the maintenance of cleanliness or lack of contamination of the copper foil sheets. One of the chief causes of contamination is the presence of resin dust, fiberglass fibers, hair, bugs and various types of foreign material resulting from the earlier manufacture and cutting of the prepreg and shipping and storing of the prepreg. Despite care, it is nevertheless inevitable that some dust remains on the copper foil surfaces.

Another cause of concern is the existence of pits or dents in the surface of the copper foil which can result from a spot of resin dust being on the foil during the heating and laminating process as it causes a depression in the copper. It can also result from handling of the very thin foil.

The presence of a pit or dent or unwanted deposit of molten resolidified resin on the surface of the copper sheet generally results in a defect in the finished product due to shorted or open conductive paths. In a finished printed circuit board are a series of parallel conductors. If there is a dent in the foil in the area where two conductors are to be formed in the imaging and the finishing process, the dent will become filled in and can cause an electrical short. Conversely, such a dent can also result in an open circuit if one of the conductors is discontinuous.

Another cause of defects results from handling the foil. When the various layers of foil and prepreg are laid one upon another, their alignment is maintained by a series of tooling pins that extend upwardly from a tooling plate. The tooling plate is a thick steel plate constituting the bottom of the stack. Each layer, be it copper foil or prepreg or partially completed laminated cores of conductive material, are pre-drilled or pre-punched with holes in a predetermined pattern, generally adhering to industry standards of size and location. Each layer is then stacked manually over the tooling pins with the pins extending upwardly through the pre-drilled holes.

One side of the foil in the finished product becomes the exposed conductive path. The other side is generally treated in an oxidizing process to produce a surface which has a roughness, is generally gray, gold or red in color, and which permits better adherence to the molten resin in the bonding process. Thin foils of ⅛ ounce and ¼ ounce and ½ ounce weights are typically used. These thin films present a difficult problem when handling. For example, wrinkles caused by handling such thin foils can result in imperfect conductive paths in the finished product.

U.S. Pat. No. 5,153,050 to Johnston addresses these problems by providing means for better foil handling and maintaining cleanliness. Each time the operator assembles the layers required to complete one printed circuit board, he must place a separator on the top of the pile and then proceed to lay-up on top of it the components of another board. He must, in the process, wipe the surfaces of not only the separator but each of the conductive foils also.

Another source of defective boards is resin bleed that takes place around the tooling pins. As stated above, each of the layers is placed upon tooling pins, which of necessity, must be somewhat smaller than the holes pre-cut into the copper foil and the prepreg layers. In the process of applying pressure and heat to the book, molten resin bleeds around the tooling pins and can fill up the tooling holes in the prepreg and foil layers. It also can bleed laterally between the various layers, particularly between the copper foil and the separator plates. After curing, this resin must be removed or it will create a resist material in the etching process. Furthermore, it can subsequently flake off onto the surface of the copper foil. Not only does the resin bleed have adverse effects on the surface of the copper, but it makes disassembly of the boards difficult when solidified resin has built up around the pins. Removal of the boards from the pins is thus made difficult.

The above mentioned '050 patent to Johnston attempts to address the above described problems by facilitating the handling of the extremely thin tissue-like copper foils while assuring that the copper foil is maintained as uncontaminated as possible before and during the manufacturing process and preventing the resin bleed that takes place around the tooling pins from flowing between layers of the boards. Johnston discloses the use of a substrate metallic sheet such as aluminum or stainless steel together with a flexible, water soluble, adhesive in the form of bands or islands at predetermined locations to join the sheet of copper foil to the metallic sheet in order to protect the thin copper foil during handling and to maintain the copper foil surface in an uncontaminated state. However, the metallic substrate is discarded and the manufacturing costs associated with using aluminum or stainless steel increases the costs of manufacturing the ultimate article, a printed circuit board.

As mentioned above, the product described in the '050 patent uses a metallic carrier to which the copper is bonded on one or both sides. The double-sided product is used when separate boards are horizontally stacked, and the aluminum or steel sheet is also used as the board separator.

The metallic separators are discarded after each lamination cycle. The use of the discardable separator increases the cost of the product thus increasing the cost of the ultimate article being fabricated. Also if aluminum or any other thin materials that are presently supplied as a part of the present product offering are used as the carrier, a problem called image transfer persists.

The Johnson patent worked well when the printed circuit boards manufactured employed 4, 6 or even 8 layers of patterned circuitry. The trend however is to increase the number of patterned layers; and it is not uncommon to manufacture printed circuit boards of 14 to 16 layers and higher.

In most printed circuit designs, it is required that all connections through the internal copper layers be aligned over each other. During pressure and heat lamination, this creates a high point or a high pressure area. The areas adjacent to these high points are low points or low pressure areas. In order to effectively bind all layers together, the board is subjected to a pressure of typically 100 to 500 pounds per square inch at an elevated temperature, which is high enough to melt and convert the resin.

The Johnson product and other current available products usually use a thin aluminum sheet to separate the boards. This sheet deforms under the lamination pressure due to the high and low pressure areas. This causes an uneven top surface which follows the pattern of the embedded circuitry and it is commonly called image transfer.

Image transfer, or uneven surfaces, causes problems of resist adhesion, and feature definition which causes rejects in the subsequent photo lithographic processes. The present invention addresses the problems associated with image transfer.

The present invention also provides a less expensive component for use in the manufacture of printed circuit boards or the like, using an unobvious substrate material with an adhesive to overcome the above described problems at a lesser cost of manufacture.

### SUMMARY OF THE INVENTION

The invention provides a component for use in the manufacture of printed circuit boards or laminates wherein a releasable laminate sheet, with an adhesive material applied at an interface between the releasable laminate sheet and a conductive foil. The releasable laminate sheet can be material such as paper or a film such as a polyester film material, instead of a metallic substrate. The adhesive is applied in a predetermined configuration such as in a band form near the outside edges of the releasable laminate sheet and conductive foil interface. The adhesive may alternatively be applied as patches or islands near the edges or in combination with the band and islands. Another embodiment applies the adhesive in a substantially uniform pattern over the surfaces of one of the conductive foil and releasable laminate sheet. The invention provides for the removal and discarding of the releasable laminate sheet and the removal of the adhesive without leaving any residue on the surface of the copper foil, thereby maintaining the uncontaminated state of the copper foil surface. When the adhesive is uniformly applied, a releasable adhesive must be use. However, non-releasable adhesive material may be used when a band and/or patches are used, as the perimeter outside edges having the adhesive is always cut away. Typically copper foil is used but any typical electrically conductive materials can or may be used, for example, nickel, cadmium, aluminum, silver and combinations of such materials may be used.

More specifically, the invention is a component for use in manufacturing articles such as printed circuit boards and laminates comprising a laminate constructed of a sheet of foil used to interconnect electronic circuitry in a finished circuit board or a finished laminate, and a temporary releasable laminate sheet which is discardable. The foil may be materials as described above, but preferably made of copper.

One surface of the sheet of foil is essentially or substantially uncontaminated and engageable with a surface of the temporary releasable laminate sheet at an interface. An adhesive is applied at an interface between the surface of the temporary releasable laminate sheet engageable with the surface of the foil sheet. The adhesive is applied in a predetermined configuration so that the uncontaminated surface of the sheet of foil can be joined together with the temporary releasable laminate sheet, such that when the temporary releasable laminate sheet is separated from the sheet of foil for discarding, the surface of the sheet of foil remains substantially uncontaminated.

The releasable laminate sheet may be a paper material or a poly film such as polyester material.

In one application of an embodiment for the configuration of the applied adhesive, the adhesive is configured as a band around and inwardly from each edge of the surface of the releasable laminate sheet for joining said surface with the surface of the sheet of foil. The adhesive would be located inwardly such that any alignment pins used in the manufacture would be inserted in holes which are preferably surrounded by adhesive.

In another configuration for the applied adhesive, the adhesive is configured as at least one island or patch of adhesive at predetermined locations around and inwardly from each edge of the surface of the releasable laminate sheet and foil for joining said surface with the surface of the sheet of foil. Again, the island(s) would be placed such that any alignment pins used in the manufacture would be inserted through an island portion of adhesive such that the pin(s) would be surrounded by an adhesive area. As mentioned above, when a band configuration or island configuration, or the combination of both is used, the adhesive may be releasable or not releasable.

In a still third method of configuring the adhesive, the adhesive may be a uniform layer applied at the interface between the surface of the temporary releasable laminate sheet and sheet of foil for joining said surface with the surface of the sheet of foil. Of course, a combination configuration of a band and island(s) may also be used. As noted above, releasable adhesive must be used for the uniformly applied configuration.

In simpler terms, the invention calls for adhering a thin protective coating, which can be a fine paper or a plastic film to the conductive foil to eliminate the problem of contamination and allowing the printed circuit manufacturer to use his own lamination separator plates of the material of his choice and reusing the separator as many times as it feels instead of discarding it after each lamination cycle as presently is the process as described in the above mentioned '050 patent.

The polymeric film can vary from polyester to polyemid and from 0.0002 mils to 0.030 mils thick depending on the temperature and duration of lamination cycle. The adhesive adherence can be done by applying the adhesive to either the shiny foil side or the releasable laminate sheet surface, which ever is preferred. Adhesives such as 3M's Post-It, or a double coated tape similar to 3M's 9425, a liquid adhesive similar to American Tambow “mono Multi” or a liquid paper dryline similar to one manufactured by the Gillette Company.

When a band configuration is utilized, a typical application would be such that the band of adhesive is from approximately 0.010 inches to approximately 2.000 inches wide and from approximately 0.00001 inches to approximately 0.005 inches thick.

When the island configuration of adhesive is applied, the typical size and thickness is from about 0.1 inches square to about 1.0 inches square and from approximately 0.00001 inches to approximately 0.005 inches thick.

When a uniform layer of adhesive is used, a recommended typical thickness is from approximately 0.00001 inches to approximately 0.005 inches thick.

In another embodiment of the invention, the component includes a laminate constructed of two sheets of foil used to interconnect electronic circuitry in either a finished circuit board or a finished laminate, and a temporary releasable laminate sheet which is discardable. One surface of each of the two sheets of foil engageable with the temporary releasable laminate sheet is substantially uncontaminated at its interfaces. The surfaces of the temporary releasable laminate sheet engageable with each of the two sheets of foil at its interfaces has a releasable adhesive applied in predetermined configurations as mentioned above so as to join the uncontaminated surfaces of the two sheets of foil together with the temporary releasable laminate sheet, such that when the two sheets of foil are separated from the temporary releasable laminate sheet for discarding said temporary releasable laminate sheet, the surfaces of the two sheets of foil remain substantially uncontaminated.

As with the first above described embodiment, the configuration of the adhesive on the releasable laminate sheet may be in the form of a band, one or more islands or a combination of islands and a band, as well as a uniform layer. Typically, the widths of the band configuration and the area size of the islands, as well as the thickness of the band, islands and uniform layer are as recommended above.

### BRIEF DESCRIPTION OF THE DRAWINGS

For a fuller understanding of the nature and objects of the invention, reference should be made to the following detailed description, taken in connection with the accompanying drawings, in which:

FIG. 1 is an enlarged sectional view of a prior art embodiment of a component for use in the manufacturing of printed circuit boards and laminates;

FIG. 2 is an enlarged sectional view of another prior art embodiment of a component for use in the manufacturing of printed circuit boards and laminates;

FIG. 3 is a schematic plan view of the prior art components depicted in FIGS. 1 or FIG. 2;

FIG. 4 is an enlarged sectional view of an embodiment of the present invention depicting a component for use in the manufacturing of printed circuit boards and laminates;

FIG. 5 is a partial schematic plan view of the component depicted in FIG. 4 showing an adhesive band and/or island configuration;

FIG. 6 is a partial schematic plan view of the component depicted in FIG. 4 showing a uniform layer of adhesive configuration;

FIG. 7 is an enlarged view of an island of adhesive with a hole in it for eventual pass through of an alignment pin during the manufacturing process;

FIG. 8 is an enlarged sectional view of another embodiment of a component for use in the manufacturing of printed circuit boards and laminates; and

FIG. 9 is a partial schematic plan view of the component depicted in FIG. 8 showing peeled back portions of each laminate layer with alternative adhesive configurations.

### DETAILED DESCRIPTION OF THE INVENTION

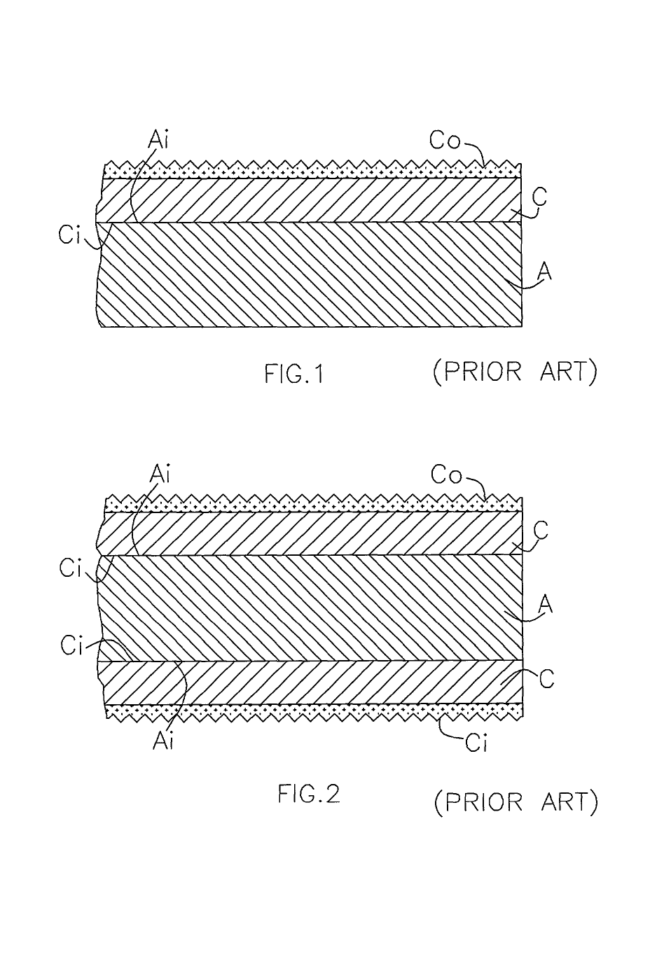

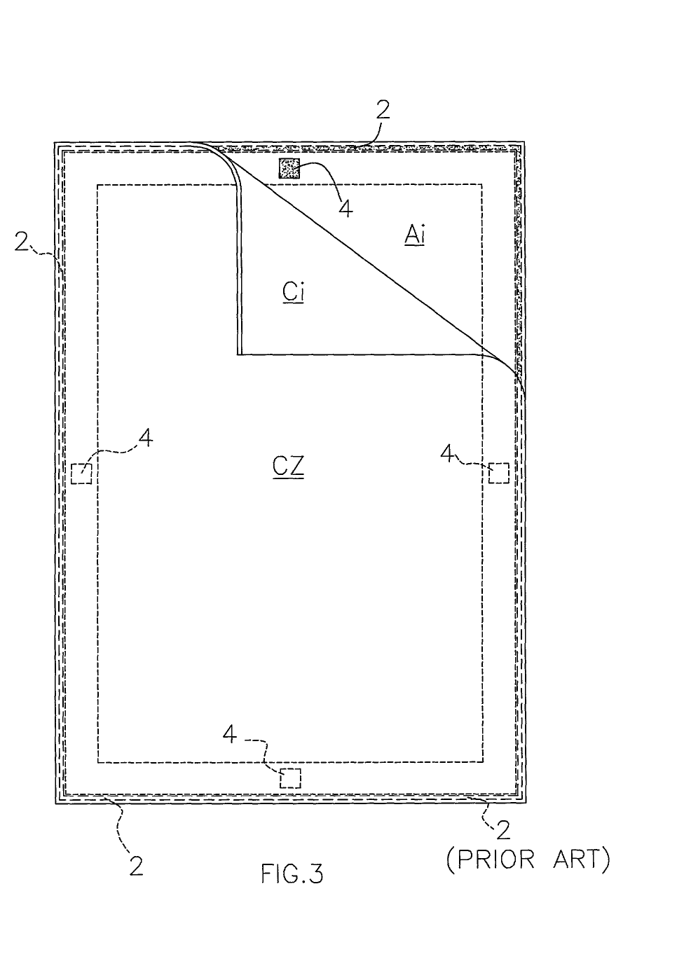

Referring now to the drawings, FIGS. 1-3 are now described in order to provide a more specific understanding of the prior art. FIGS. 1-3 depict simple prior art laminated components. Particularly, FIG. 1 depicts a simple prior art copper foil and aluminum substrate configuration where the inner surface Aᵢ of an aluminum (or stainless steel) substrate interfaces to the inner surface C_{I} of the copper foil C. The copper foil has an outer surface C_{O} which is preoxidized. FIG. 2 depicts another prior art arrangement where the copper foil C is on both sides of the substrate A. FIG. 3 depicts a how the substrate inner surface Aᵢ is adhesively attached to the copper foil inner surface Cᵢ using a band 2 of adhesive around the perimeter of the substrate inner surface Aᵢ and/or islands 4 of adhesive inwardly from the edges of the substrate inner surface Aᵢ. The band 2 and/or islands 4 or patches of adhesive define the effective boundary of a centralized uncontaminated zone CZ. In the industry, these laminated components are frequently referred to as a CAC signifying the copper, aluminum and copper laminates. Using aluminum sheets or stainless steel sheets significantly increases production costs.

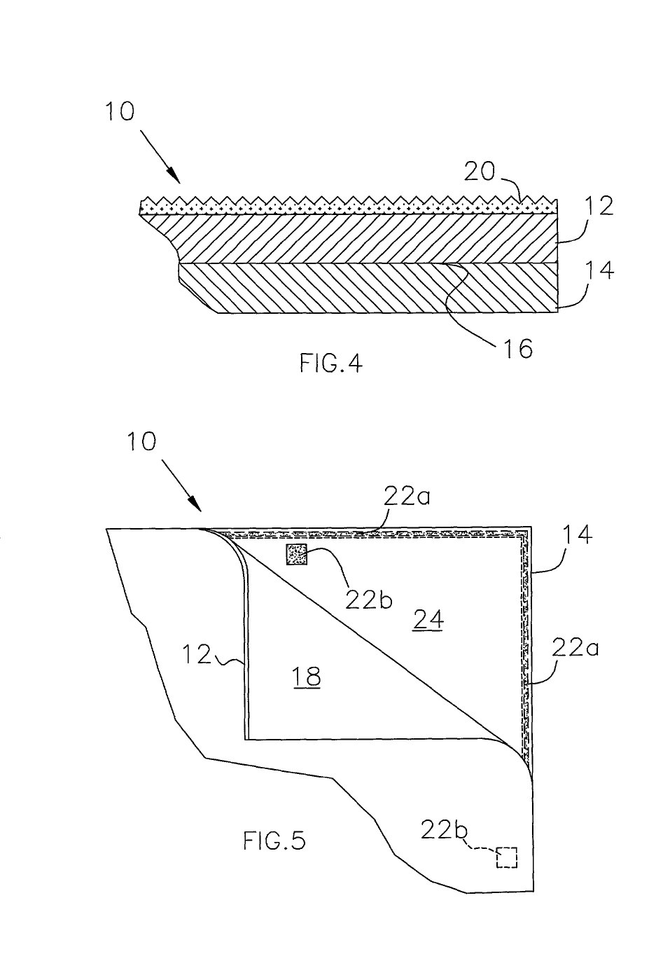

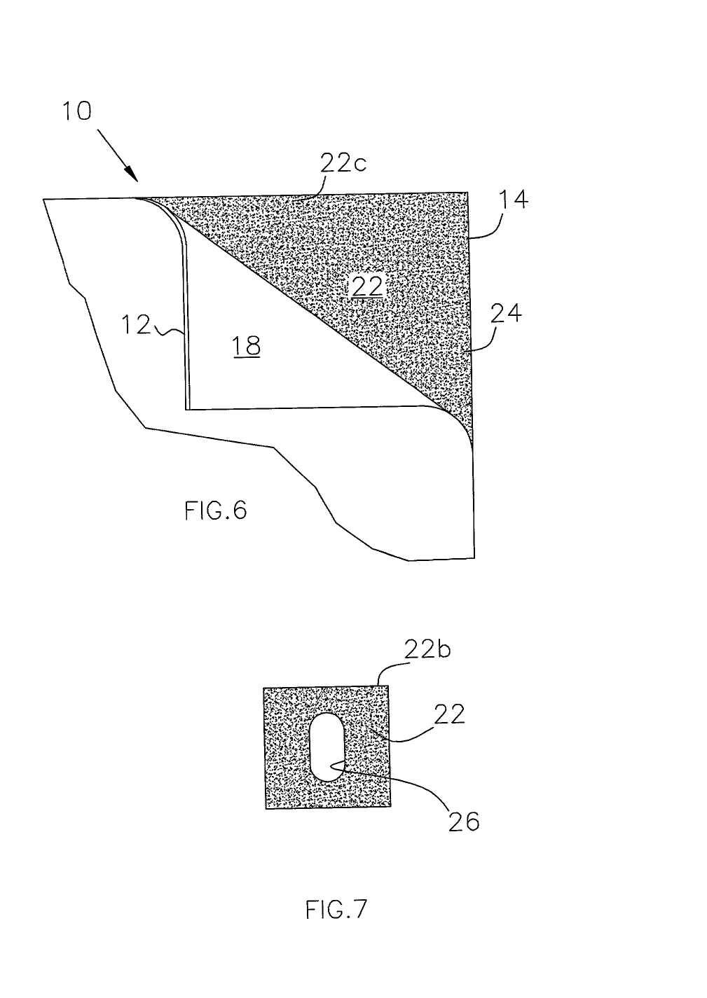

As shown in FIGS. 4-6, the invention which is a component for use in manufacturing articles such as printed circuit boards and laminates, depicted generally as 10, comprises a laminate constructed of a sheet of foil 12 used to interconnect electronic circuitry in one of a finished circuit board and a finished laminate, and a temporary releasable laminate sheet 14 which is discardable. The inner surface 18 of the sheet of foil 12 is substantially uncontaminated and engageable with a surface 24 of the temporary releasable laminate sheet 14 at an interface 16. An adhesive 22 is applied at the interface 16, either on the surface 24 of the temporary releasable laminate sheet 14 or on the foil sheet 12, in predetermined configurations for joining the uncontaminated inner surface 18 of the sheet of foil 12 together with the temporary releasable laminate sheet 14, such that when the temporary releasable laminate sheet 14 is separated from the sheet of foil 12 for discarding, the surface 18 of the sheet of foil 12 remains substantially uncontaminated.

In one configuration of adhesive used in the invention, the adhesive 22 is configured as a band 22a around and inwardly from each edge of the surface 24 of the releasable laminate sheet 14 and foil surface 18 for joining said surface 24 with the surface 18 of the sheet of foil 12. The adhesive 22 may be applied to one of the surface 24 or surface 18.

The drawings herein depict the adhesive applied to the surface 24 for convenience sake only. The adhesive 22 may be applied equally as well on the surface 18 of foil 12.

In another configuration of the adhesive used in the invention, the adhesive 22 is configured as at least one island 22b of adhesive 22 at predetermined locations around and inwardly from each edge of the surface 24 of the releasable laminate sheet 14 and surface 18 of foil 12 for joining said surface 24 with the surface 18 of the sheet of foil 12.

In still another configuration, the adhesive 22 is configured as a uniform layer 22c on the surface 24 of the temporary releasable laminate sheet 14 or surface 18 of the foil 12 for joining said surface 24 with the surface 18 of the sheet of foil 12.

A combination configuration may also be utilized such as a band 22a around and inwardly from each edge of the surface 24 of the releasable laminate sheet 14 and surface 18 of the sheet of foil 12, for joining said surface 24 with the surface 18 of the sheet of foil 12, and at least one island 22b of adhesive 22 at predetermined locations around and inwardly from each edge of the surface 24 of the releasable laminate sheet 14 and surface 18 of the sheet of foil 12, for joining said surface 24 with the surface 18 of the sheet of foil 12.

When a band configuration is used, a typical application of the invention may apply the adhesive 22 such that it is from approximately 0.010 inches to approximately 2.000 inches wide and from approximately 0.00001 inches to approximately 0.005 inches thick. When islands 22b of adhesive 22 is applied, typically the size and thickness of the adhesive may be from about 0.1 inches square to about 1.0 inches square and from approximately 0.00001 inches to approximately 0.005 inches thick. A uniform layer 22c of adhesive 22 may typically be from approximately 0.00001 inches to approximately 0.005 inches thick.

As previously mentioned, the foil 12 may be made from several materials, although copper is preferred. As in the prior art, the copper foil would also have a preoxidized outer surface 20. During the manufacturing process, it is anticipated that holes 26 be provided where appropriate near the edges of the component 10 such that the holes 26 are surrounded by adhesive 22 so that alignment pins entering the holes will be surrounded by an area with adhesive 22. For example, FIG. 7 depicts an island 22b of adhesive with hole 26.

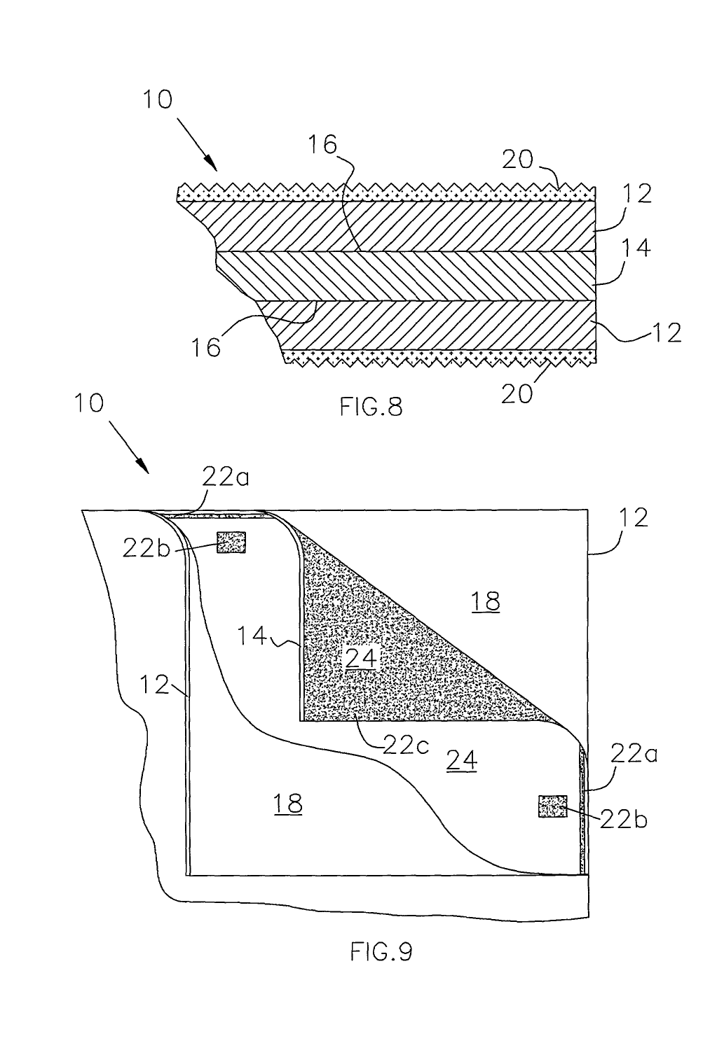

Another embodiment of the invention is depicted in FIGS. 8 and 9, wherein the component 10 for use in manufacturing articles such as printed circuit boards and laminates comprises a laminate constructed of two sheets of foil 12 used to interconnect electronic circuitry in either a finished circuit board or a finished laminate, and a temporary releasable laminate sheet 14 which is discardable. One surface 18 of each of the two sheets of foil 12 engageable with the temporary releasable laminate sheet 14 is substantially uncontaminated at its interfaces 16. The surfaces 24 of the temporary releasable laminate sheet 14 engageable with each of the two sheets of foil 12 at its interfaces 16 have an adhesive 22 applied in predetermined configurations on said surfaces 24 of the temporary sheet 14 or on said surfaces 18 of the sheets of foil 12 for joining the uncontaminated surfaces 18 of the two sheets of foil 12 together with the temporary releasable laminate sheet 14, such that when the two sheets of foil 12 are separated from the releasable laminate sheet 14 for discarding said temporary releasable laminate sheet 14, the surfaces 18 of the two sheets of foil 12 remain substantially uncontaminated.

The adhesive 22 may be configured in the same manner as the first embodiment described above except that the adhesive 22 is applied in a band 22a, an island 22b or a uniform layer 22c configuration. Further, the typical application of the amount of adhesive 22, including area sizes of islands 22b, band 22a width and associated thickness for the band 22a and islands 22b, and uniform layer 22c thickness is similar to that described above for the first embodiment.

It is anticipated that several series of component laminates may be manufactured. For example, if the first embodiment was symbolically denoted C-P for copper foil/temporary releasable laminate sheet, or if the second embodiment were symbolically denoted C-P-C for a copper foil/temporary releasable laminate sheet/copper foil combination, then other combinations are possible such as C-P-C-P-C-P-C . . . and so on.

The invention therefore allows for the maintenance of essentially a complete uncontaminated surface 18 on the foil, contrary to the prior art laminates which created an uncontaminated central zone only such as that depicted as CZ in FIG. 3.

As seen from the foregoing description, the present invention satisfies a long felt need to provide a component for use in manufacturing articles such as printed circuit boards and laminates which if significantly less expensive to manufacture and more effective, thereby providing valuable cost savings.

The invention is clearly new and useful. Moreover, it was not obvious to those of ordinary skill in this art at the time it was made, in view of the prior art considered as a whole as required by law.

It will thus be seen that the objects set forth above, and those made apparent from the foregoing description, are efficiently attained and since certain changes may be made in the above construction without departing from the scope of the invention, it is intended that all matters contained in the foregoing construction or shown in the accompanying drawings shall be interpreted as illustrative and not in the limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A component for use in manufacturing articles such as printed circuit boards and laminates comprising:
a laminate constructed of a sheet of foil used to interconnect electronic circuitry in one of a finished circuit board and a finished laminate, and a temporary releasable laminate sheet which is discardable;
one surface of the sheet of foil being substantially uncontaminated and engageable with a surface of the temporary releasable laminate sheet at an interface; and
an adhesive applied to one of the surface of the temporary releasable laminate sheet and the one surface of the foil sheet in a predetermined configuration at the interface for joining the uncontaminated surface of the sheet of foil together with the temporary releasable laminate sheet,
wherein when the temporary releasable laminate sheet is separated from the sheet of foil for discarding, the surface of the sheet of foil remains substantially uncontaminated, and
wherein the temporary releasable laminate sheet is one of release paper and a polymeric film.

2. The component for use in manufacturing articles such as printed circuit boards and laminates according to claim 1,
wherein the applied adhesive is configured as a band around and inwardly from each edge of the surface of the releasable laminate sheet and the one surface of the sheet of foil for joining said surface of the releasable laminate sheet with the surface of the sheet of foil.

3. The component for use in manufacturing articles such as printed circuit boards and laminates according to claim 1,
wherein the applied adhesive is configured as at least one island of adhesive at predetermined locations around and inwardly from each edge of the surface of the releasable laminate sheet and surface of the sheet of foil, for joining said surface of the releasable laminate sheet with the surface of the sheet of foil.

4. The component for use in manufacturing articles such as printed circuit boards and laminates according to claim 1,
wherein the applied adhesive is configured as a uniform layer on one of the surface of the temporary releasable laminate sheet and the surface of the sheet of foil, for joining said surface of the releasable laminate sheet with the surface of the sheet of foil.

5. The component for use in manufacturing articles such as printed circuit boards and laminates according to claim 1,
wherein the applied adhesive is configured:
as a band around and inwardly from each edge of the surface of the releasable laminate sheet for joining said surface of the releasable laminate sheet with the surface of the sheet of foil, and
as at least one island of adhesive at predetermined locations around and inwardly from each edge of the surface of the releasable laminate sheet and surface of the sheet of foil, for joining said surface of the releasable laminate sheet with the surface of the sheet of foil.

6. The component for use in manufacturing articles such as printed circuit boards and laminates according to claim 2,
wherein the band of adhesive is from approximately 0.010 inches to approximately 2.000 inches wide and from approximately 0.00001 inches to approximately 0.005 inches thick.

7. The component for use in manufacturing articles such as printed circuit boards and laminates according to claim 5,
wherein the band of adhesive is from approximately 0.010 inches to approximately 2.000 inches wide and from approximately 0.00001 inches to approximately 0.005 inches thick.

8. The component for use in manufacturing articles such as printed circuit boards and laminates according to claim 3,
wherein the at least one island of adhesive is from about 0.1 inches square to about 1.0 inches square and from approximately 0.00001 inches to approximately 0.005 inches thick.

9. The component for use in manufacturing articles such as printed circuit boards and laminates according to claim 5,
wherein the at least one island of adhesive is from about 0.1 inches square to about 1.0 inches square and from approximately 0.00001 inches to approximately 0.005 inches thick.

10. The component for use in manufacturing articles such as printed circuit boards and laminates according to claim 4,
wherein the uniform layer of adhesive is from approximately 0.00001 inches to approximately 0.005 inches thick.

11. A component for use in manufacturing articles such as printed circuit boards and laminates comprising:
a laminate constructed of two sheets of foil used to interconnect electronic circuitry in one of a finished circuit board and a finished laminate, and a temporary releasable laminate sheet which is discardable;
one surface of each of the two sheets of foil engageable with the temporary releasable laminate sheet being substantially uncontaminated at its interfaces; and
an adhesive applied to one of the surface of the temporary releasable laminate sheet and the one surface of each of the two sheets of foil in a predetermined configuration at the interfaces for joining the uncontaminated surfaces of the two sheets of foil together with the temporary releasable laminate sheet,
wherein when the two sheets of foil are separated from the temporary releasable laminate sheet for discarding said temporary releasable laminate sheet, the surfaces of the two sheets of foil remain substantially uncontaminated, and
wherein the temporary releasable laminate sheet is one of release paper and a polymeric film.

12. The component for use in manufacturing articles such as printed circuit boards and laminates according to claim 11,
wherein the adhesive is configured as a band around and inwardly from each edge of the surfaces of the temporary releasable laminate sheet and the uncontaminated surfaces of the two sheets of foil, for joining said surfaces of the temporary releasable laminate sheet with the uncontaminated surfaces of the two sheets of foil.

13. The component for use in manufacturing articles such as printed circuit boards and laminates according to claim 11,
wherein the applied adhesive is configured as at least one island of adhesive at predetermined locations around and inwardly from each edge of the surfaces of the temporary releasable laminate sheet and the surfaces of the two sheets of foil, for joining said surfaces of the temporary releasable laminate sheet with the surfaces of the two sheets of foil.

14. The component for use in manufacturing articles such as printed circuit boards and laminates according to claim 11,
wherein the applied adhesive is configured as a uniform layer on one of the surfaces of the temporary releasable laminate sheet and the surfaces of the two sheets of foil, for joining said surfaces of the temporary releasable laminate sheet with the surfaces of the two sheets of foil.

15. The component for use in manufacturing articles such as printed circuit boards and laminates according to claim 11,
wherein the applied adhesive is configured:
as a band around and inwardly from each edge of the surfaces of the temporary releasable laminate sheet and surfaces of the two sheets of foil, for joining said surfaces of the temporary releasable laminate sheet with the surfaces of the two sheets of foil, and
as at least one island of adhesive at predetermined locations around and inwardly from each edge of the surfaces of the temporary releasable laminate sheet and the surfaces of the two sheets of foil, for joining said surfaces of the temporary releasable laminate sheet with the surfaces of the two sheets of foil.

16. The component for use in manufacturing articles according to claim 12,
wherein the band of adhesive is from approximately 0.010 inches to approximately 2.000 inches wide and from approximately 0.00001 inches to approximately 0.005 inches thick.

17. The component for use in manufacturing articles such as printed circuit boards and laminates according to claim 15,
wherein the band of adhesive is from approximately 0.010 inches to approximately 2.000 inches wide and from approximately 0.00001 inches to approximately 0.005 inches thick.

18. The component for use in manufacturing articles such as printed circuit boards and laminates according to claim 13,
wherein the at least one island of adhesive is from about 0.1 inches square to about 1.0 inches square and from approximately 0.00001 inches to approximately 0.005 inches thick.

19. The component for use in manufacturing articles such as printed circuit boards and laminates according to claim 15,
wherein the at least one island of adhesive is from about 0.1 inches square to about 1.0 inches square and from approximately 0.00001 inches to approximately 0.005 inches thick.

20. The component for use in manufacturing articles such as printed circuit boards and laminates according to claim 15,
wherein the uniform layer of adhesive is from approximately 0.00001 inches to approximately 0.005 inches thick.
